(19) United States
(12) Patent Application Publication
(10) Pub. No.: US 2008/0061918 A1
(43) Pub. Date: Mar. 13, 2008

(54) Inductive Component Fabrication Process

(76) Inventor: Paul Greiff, Wayland, MA (US)

Correspondence Address: Brian M. Dingman, Esq.;Mirick, O'Connell, DeMallie & Lougee, LLC, 1700 West Park Drive, Westborough, MA, 01581, US

(21) Appl. No.: 11/530,069

(22) Filed: Sep. 8, 2006

(51) Int. Cl. H01F 5/00

(52) U.S. Cl. 336/200

(57) ABSTRACT

A process for fabricating elongated inductive components that have one or more conductors surrounded along their active length by a magnetic layer. A substrate is provided having one or more narrow, elongated deposition regions, each such region bordered on both elongated sides by elongated openings in the substrate, so that at least some of each such region is accessible along all sides. Conductors are provided on these regions. An insulator is deposited over the conductors. A magnetic layer is deposited over the insulator.

### FIELD OF THE INVENTION

This invention relates to processes for fabricating inductive components such as inductors and transformers.

### BACKGROUND OF THE INVENTION

The traditional methods of forming an inductor or transformer are to wind a copper wire around a torroidal or bar shaped soft magnetic material core.

Prior methods of using thin film technology have been proposed for fabricating magnetic components. See U.S. Pat. No. 5,847,634, issued on Dec. 8, 1998. The thin film designation refers to material deposited by such methods as: vacuum sputtering, electroplating, silk screening, etc. and often shaped by photolithography. The prior art thin film configurations most relevant to the invention herein use a central copper core with the magnetic material deposited around the core and separated from it by a dielectric insulator. All of these prior methods, however, use a solid substrate, and all processing is done from one side of the substrate.

The Korenivski et al. closed flux path embodiment requires two separate depositions of magnetic material and four photolithography steps for each magnetic layer. These additional steps can effect quality and yield. Also, the overlapping of the two magnetic material layers creates a boundary in the magnetic layer. The magnetic flux thus must cross a physical boundary, which will reduce inductance and decrease device efficiency.

### SUMMARY OF THE INVENTION

The invention comprises methods for fabricating inductive magnetic components, i.e. inductors and transformers. The inventive processes use thin film deposition techniques rather

than the typical wire wound core methodology. The inventive processes can be used to form many components on a single substrate at the same time, thus reducing the cost of the individual components. Also, several types of components may be formed at the same time, increasing packaging density and further lowering the cost of the overall circuitry.

The invention is based in part on a design concept described in U.S. Pat. No. 6,233,834 issued May 22, 2001, the entire disclosure of which is hereby incorporated by reference. The invention contemplates a two-sided method of fabricating the devices disclosed in this patent, and extends the design geometry to include coil type structures.

### BRIEF DESCRIPTION OF THE DRAWINGS

Other objects, features and advantages will occur to those skilled in the art from the following description of the preferred embodiment, and the accompanying drawings, in which:

FIG. 1 is a schematic, cross-sectional diagram of an inductive component made by one embodiment of the invention;

FIG. 2 is a schematic top view of another inductive component made according to the invention;

FIGS. 3A and 3B are similar top and bottom views, respectively, of another inductive component that can be fabricated according to the invention;

FIGS. 4A-4E are schematic, cross-sectional diagrams showing a sequence of steps involved in another embodiment of the invention;

FIGS. 5A-5E are schematic, cross-sectional diagrams showing a sequence of steps involved in another embodiment of the invention; and

FIG. 6A is a schematic top view, and FIG. 6B a schematic cross-sectional view taken along line A-A of FIG. 6A, showing a more traditional inductive component construction in which a core with a central opening is wrapped with wire turns.

### DETAILED DESCRIPTION OF THE PREFERRED EMBODIMENTS

The invention preferably uses both faces of an insulating substrate to achieve a major simplification in processing and a nominal four to one increase in inductance per unit area of substrate. The invention allows the magnetic layer to be deposited in one continuous layer, thus avoiding the magnetic interface associated with the prior art patent referenced above. The invention further decreases the number of photolithographic steps required to fabricate a thin-film based inductive component.

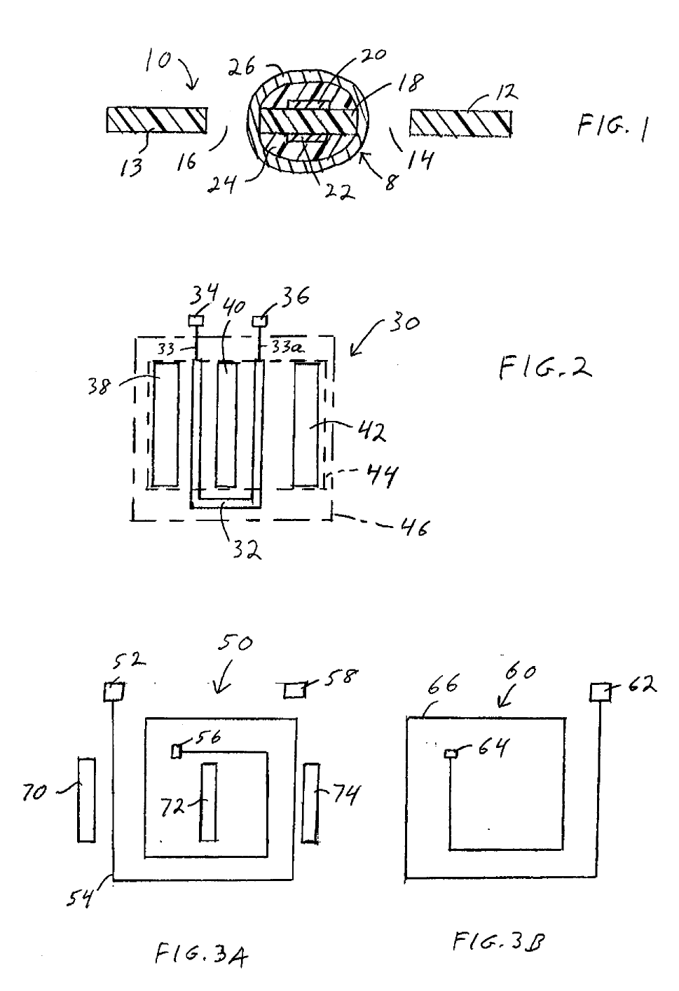

FIG. 1 illustrates inductive component 8 made according to one embodiment of the invention. Component 8 is made by deposition on substrate 10. Slots or similar openings 14 and 16 in substrate 10 create elongated substrate regions 12, 13 and 18, each of which can become the central support section of an inductive component. Only a single component 8 is depicted in the drawing, solely for purposes of clarity of the drawing.

Component 8 comprises conductors 20 and 22, deposited overlying insulating portion 24 that envelops the conductors, and overlying magnetic layer 26. As shown in FIG. 1, the continuous magnetic layer 26 eliminates the magnetic layer overlap boundary structure and non-magnetic interface occurring in the Korenivski patent referred to above.

FIG. 1 also depicts a second conductor 22 on the opposite face of the substrate from conductor 20. This conductor is easily incorporated and gives major improvements in performance: it allows doubling the number of coil turns per unit area, and twice the number of turns gives four times the inductance. Alternative uses of the second metal layer can be to increase effective conductor thickness, or to form the secondary of a transformer.

The wrap-around magnetic layer gives excellent magnetic coupling between the conductors. Also, the construction prior to deposition of magnetic material gives a smooth oval shape such that very thin layers of magnetic material can be used. This is useful at high frequency since only the skin depth thickness of the magnetic material is effective. Excess magnetic material gives a large variation of inductance with frequency, which can be detrimental to certain circuits.

The invention comprises a substrate having one or more narrow, elongated deposition regions, each such region bordered on both elongated sides by openings in the substrate, so that at least most of each such region is accessible along all sides. In the preferred embodiment, rectangular cuts are made through the substrate to create the openings. As a result, the geometry is such that the magnetic layer may be applied around the entire cross sectional circumference of the device at the same time in one continuous layer. The layer(s) may be applied by electroplating, electroless plating, or vacuum deposition, or similar thin-film deposition methods. In the case of vacuum deposition, the substrate may be rotated to obtain a more uniform continuous layer. Numerous schemes may be employed, but in each case the use of the slots obviates the need for complex photolithography at each step.

The substrate is an electrical insulator that also serves as a structural support for the device. Alumina is attractive because it has considerable strength and rigidity as well as being a good insulator. The conductors formed on the elongated regions may be a straight line or a meander or a coil like geometry. The slots may be introduced at a convenient time in the process, but must be in place prior to the deposition of magnetic material.

### DESCRIPTION OF PARTICULAR PREFERRED EMBODIMENTS OF THE INVENTION

### Ceramic Substrate Process Embodiment

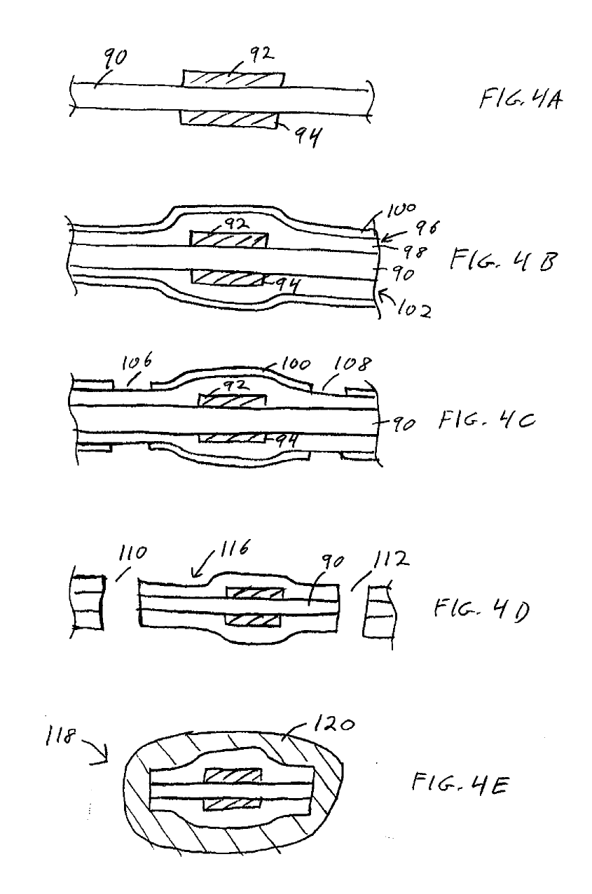

In this embodiment a hard-fired alumina, typically 0.015″ thick, or similar substrate may be used. FIG. 2 illustrates device 30 made by the process. Device 30 is a single turn design such as shown in FIG. 1. FIG. 3 illustrates a similar coil design.

Device 30, FIG. 2, is made by providing a suitable substrate, and creating elongated openings such as slots 38, 40 and 42 through the substrate thickness. Such slots may be cut by a saw or ablated by a laser, for example. These slots in the substrate straddle the conductors and vias which are used to connect the front and back conductors, when two conductors are used. Laser ablation is typically used for this process. A typical substrate thickness is 0.020″ and a suitable slot width is about 0.030″. Next the conductor is applied typically by silk screening of a silver paste, thickness 0.001″ to 0.002″, and firing at a high temperature. FIG. 2 shows only the front face geometry, with “U”-shaped conductor 32 that is electrically connected to pads 34 and 36 through traces 33 and 33a. If the back face is used, a similar “U”-shaped conductor is applied, lying directly below conductor 32. Vias that overlap both conductors accomplish the electrical connection between conductors through the substrate thickness. In some designs the vias can be filled with the conductive paste. In higher current devices it may be necessary to accomplish the vias with plated-through holes.

Next, a dielectric is applied to cover the entire faces of the substrate except where electrical contact is to be made to the conductors, which is typically at pads 34 and 36. The dielectric-covered area is depicted in the drawing as the area bounded by dashed line 46. Silk screening of a glass frit, typically 0.002″, and firing at high temperature may be used for this step. A particularly convenient process in use by the ceramics industry is a wrap-around glaze. In this process, the glaze is drawn through the slots so as to form a smooth oval shape to the cross section. As shown in cross section in FIG. 1, this oval shape lends itself to coverage by one or more thin magnetic layers that are necessary for high frequency performance. For example, the skin depth for Permalloy at one MHz is about 4 to 8 microns depending on the permeability and this would be the desirable thickness of the magnetic layer. Magnetic material is then deposited over the conductors and within the slots; the deposition area is depicted in the drawing as the area bounded by dashed line 44. The magnetic material may be applied as a continuous film around the central section between the slots, or over the entire area except where electrical contact is required to the conductors.

Magnetic laminations may be formed by alternating depositions of magnetic material and insulator. Vacuum deposition is sometimes advantageous in that only a single pump-down is required to sequentially deposit both magnetic material and insulator. During deposition a simple mask can be used to protect certain areas of the conductors for subsequent electrical contact. This mask could be left in place during the entire lamination process. There is no theoretical limit to the number of laminations that may be formed in sequence in this manner without the use of intervening photolithographic steps. However, because of magnetic shielding effects caused by multiple layers surrounding a conductor, the number of effective laminations is limited.

FIGS. 3A and 3B show the front and back side, respectively, of a coiled form, which is fabricated in essentially the same manner. Coil 54 is connected on the top side to connection pad 52, while pad 58 is connected to pad 62 by a via. Pads 56 and 64 are likewise interconnected by a via. Slots 70, 72 and 74 allow for one or more wrap-around magnetic laminations. This drawing also illustrates more than one turn in each segment between slots.

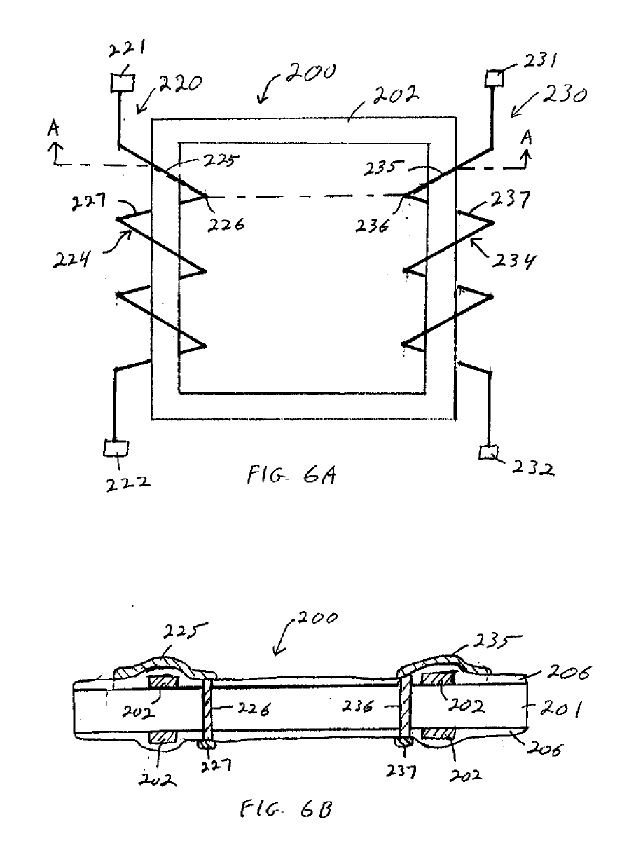

For compactness, the topology of the device may be a meander, with interconnections between adjacent sections of the meander (for example as accomplished by interruptions in the slotting of the substrate) provided to hold the structure in place. The meander geometry used for inductors and transformers is described in the patent that is incorporated by reference herein; see for example FIG. 6. In the present instance, though, there would be slots or other opening parallel to the long legs of the meander, to allow for the wrap-around magnetics. However, coil geometry is more common than a meander geometry, as it generally gives higher inductance for a given substrate area.

Although for clarity only inductors have been illustrated, the identical process may be used to build transformers and combinations of devices may also be fabricated on the same substrate with the same process. The major difference will be in the conductor pattern and the types of connections to the conductor. Also, if the conductors on the two sides of the substrate are not electrically interconnected, the construction will function as a transformer.

### Flexible Cable Substrate Process Embodiment

In this embodiment the substrate may be obtained in sheet form as a copper/Kapton/copper composite. Such substrates are mass produced for the flexible cable industry. Typical dimensions are 0.002″ for each layer.

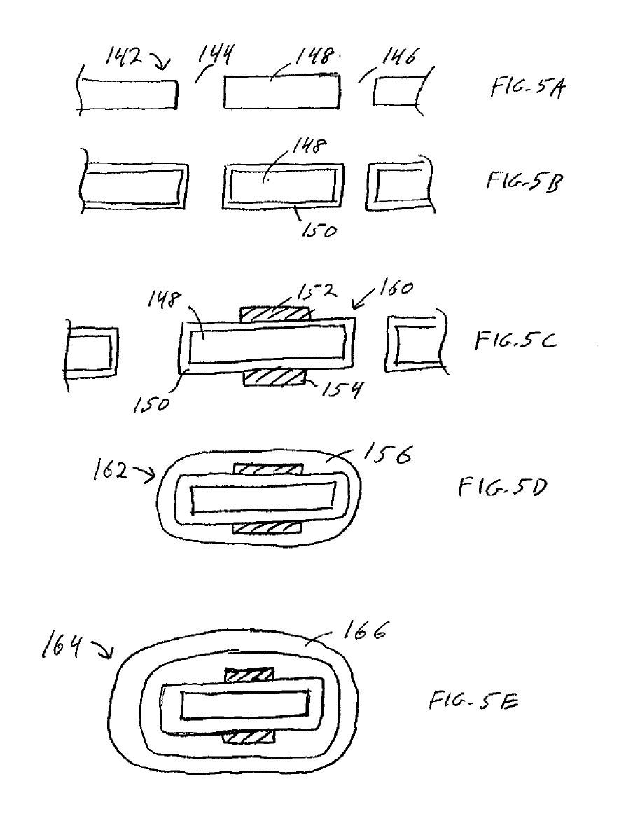

The process is illustrated in FIGS. 4A-4E. A simple geometry is shown for illustration. In practice a coil or meander geometry as described in the prior incorporated patent is typically employed. In the first step, FIG. 4A, the top and bottom layers of copper are patterned using photolithography, for example through an etch step, leaving conductive traces 92 and 94 on substrate 90. The substrate is next, FIG. 4B, laminated on both sides with a film (identical films 96 and 102 are illustrated) consisting of polyimide layer 98, typically about 0.002″ thick, coated with a thin film 100 of copper, nominally 1 to 5 microns. In all the steps the top and bottom surfaces are symmetrically processed.

In step 4C, the outer copper layer 100 is patterned by lithography and selectively removed by chemical etching in the areas 106 and 108 where the slots are to be formed. The substrate is now etched in an oxygen plasma, with the copper pattern serving as a mask so as to form slots 110 and 112 in the substrate, FIG. 4D. At the same time the plasma etch is used to etch through the outer layer of plastic laminate to form a contact via to the conductors, the vias not shown in this set of drawings. This can be done in the same operation as the layer of conductor copper serves as an etch stop. Oxygen plasma is used to etch plastic as opposed to metal films. After slot formation this outer layer of copper is totally removed by non-selective etching, also as shown in FIG. 4D, to give the fundamental cross section 116 similar to that shown in FIG. 1.

Permalloy layer 120 is then uniformly deposited on top of the insulator and surrounding the conductor as shown in FIG. 4E, resulting in a device 120 with a cross section similar to that of FIG. 1. In some cases a magnetic field is employed along the long axis of the inductor, to orient the magnetic material, as described in the incorporated patent. For transformer construction the copper is divided into separate electrically isolated conductors. Conductor materials other than copper may be used. Other methods of forming slots such as laser cutting may be employed. A typical soft magnetic material is Permalloy, 80/20 nickel/iron, however any soft magnetic material may be employed.

The final construction shown in FIG. 4E gives similar options for forming magnetic devices as the ceramic substrate process. Because flexible cable stock is handled in very large sheets it is expected that this will be an inexpensive method of fabricating devices.

### Silicon Wafer Process Embodiment

The process is illustrated in FIGS. 5A-5E. A single crystal silicon wafer or a square polysilicon or an integrated circuit substrate 142, FIG. 5A, may be used as the starting material. In the case of an integrated circuit all steps must take place at relatively low temperature so as not to damage the existing devices. In the first step the substrate, typically 0.020″ thick, is patterned by photolithography and slots 144 and 146 are etched through the wafer in a desired pattern. Plasma etching is readily used for this purpose. The wafer is thermally oxidized to create an insulating layer 150, typically having a thickness of about one micron, FIG. 5B. Alternatively a low temperature CVD deposition of SiO2 may be used of about one micron thickness. Next thin film conductors 152 and 154, typically about 1 to 3 microns thickness, are deposited on the top and bottom of the wafer and patterned by lithography. A subsequent photo step and electroplating may be used to build up the thickness of the conductor. A dielectric layer 156 is deposited by CVD (chemical vapor deposition) or other means, and once again a cross section 162, FIG. 5D, similar to that of FIG. 1 is obtained. Typical dielectric thickness is a few microns. A mask and etch operation, not shown, is required to obtain electrical access to the conductors prior to magnetic deposition. The magnetic layer(s) 166 are now deposited, FIG. 5E, by similar technique as for the other substrates. Masking is required to prevent the magnetic material from electrically shorting to the conductors and to expose the conductors for electrical contact. This masking may be by photolithography or by mechanical means as in shadow masking (the use of a mechanical mask with necessary openings placed over the substrate). The final device 164 is shown in FIG. 5E.

Note that electrical isolation of magnetic material from the conductor is necessary for all the processes and embodiments described above. Another alternative to achieve this purpose, which works well for relatively thin layers of magnetic material, is to deposit the laminations over the entire surface, with a following photo step and etching to remove the films from over the exposed electrical contacts to the conductors.

### Wire-Wrapped Core Process Embodiment

FIGS. 6A and 6B illustrate the use of two-sided processing in a more traditional construction in which a core with a central opening is wrapped with wire turns, so that the conductors are on the outside of the magnetic core material. Inductive member 200 comprises substrate 201 (which may be aluminum oxide) on which (on one or both sides) is overlayed core 202 comprising one or more magnetic laminations. Glass insulating layer 206 covers the substrate and the core. Multiple turn windings 220 and 230 are accomplished with metal traces layered on top of layers 206, both above the top surface of substrate 201 and below the bottom surface of substrate 201. Laser cut, metal-filled, through-substrate vias, such as vias 226 and 236, accomplish the electrical connection from one winding segment to another. For example, winding segment 225 on top of substrate 201 is electrically connected to winding segment 227 on the bottom of substrate 201 by via 226. The result is a series of turns around the core, fabricated in a similar thin-film deposition process. Two-sided processing for this construction also is a much simpler process than similar designs fabricated on one side only.

### ADVANTAGES OF THE INVENTION

The processes described above have all or some of the following advantages:

1. The two sided process has fewer steps than the one sided and may be a lower cost process. This is particularly true where multiple laminations are used.
2. The preferred embodiment using a ceramic substrate gives a very rugged construction. The wrap around glaze insulation that ceramic processing allows enables the use of thick conductors and still gives a smooth oval shape for coating with thin layers of magnetic material.
3. The double sided process provides a low cost highly simplified method of obtaining two independent conductor patterns in the same area of substrate. The advantage can be taken as either thicker conductors, or twice the turns per unit area, which would result in a factor of four higher inductance. Also the topology is smoother because the conductors are not physically on top of one another and the process is less prone to pinholes and shorts between conductors or breaks in the continuity of the conductor traces.

### 4. Magnetic laminations, which are used for high frequency operation, may be obtained by sequential vacuum deposition of the required layers with no additional photolithography steps required.

Other deposition methods such as plating may require the use of separate operations for application of magnetic material and insulator but do not require additional photolithography.

A distinction is made between the kind of masking required by the process of the invention which serves to protect the electrical contacts by tape or a shadow mask, and the more elaborate process of photolithography as required by the single sided process. A single sided process cannot form continuous layers of either magnetic material or insulator around the conductors without the use of two photolithography steps per layer, one for the insulator and one for the magnetic material. Even at that the continuity is obtained through an overlapping joint, which as described above could be problematic.

5. By having magnetic layers, and laminations including them, that are formed in a continuous film instead of an overlap process, a more effective lamination is achieved. The lines of flux are not required to cross a physical boundary such as is the case for overlapping layers formed by separate operations. Such boundaries can give minute gaps via oxide films that affect performance. Good laminations are required to achieve high efficiency devices and high efficiency is critical for high power devices. Even if only one lamination is used it is of higher quality than the prior art of overlapping layers.

### 6. By not involving photolithography in the application of the magnetic layer or in the formation of magnetic laminations, a lower cost process is achieved.

7. For the silicon and ceramic substrates no organic material need be used. This results in a higher maximum temperature of operation and better heat conduction out of the device. Both are important for maximizing the power handling capability, stability, and reliability of the devices.
8. The process lends itself to the formation of multiple magnetic components on one substrate, creating a form of magnetic integrated circuit that is suitable for high frequency high power applications, thereby giving a very cost effective method of constructing such circuits.

Although specific features of the invention are shown in some drawings and not others, this is for convenience only as the various features may be combined in accordance with the invention.

Other embodiments will occur to those skilled in the art and are within the scope of the following claims.

What is claimed is:

1. A process for fabricating elongated inductive components comprising one or more conductors surrounded along their active length by a magnetic layer, the process comprising:
providing a substrate having one or more narrow, elongated deposition regions, each such region bordered on both elongated sides by elongated openings in the substrate, so that at least some of each such region is accessible along all sides;
providing on the regions one or more conductors;
depositing an insulator over the conductors; and
depositing a magnetic layer over the insulator.

2. The process of claim 1 wherein the magnetic layer comprises a series of alternating magnetic layers and intervening insulator films, to create magnetic laminations in the layer.

3. The process of claim 2 in which multiple dielectrically isolated magnetic laminations are deposited without the use of photolithography.

4. The process of claim 2 in which multiple dielectrically isolated magnetic laminations are deposited in a single pumpdown in the case of sputtered films.

5. The process of claim 1 in which the openings comprise slots in the substrate.

6. The process of claim 1 in which a plurality of components are created at the same time on the same substrate, to create a magnetic integrated circuit device.

7. The process of claim 6 in which the magnetic integrated circuit is adapted for high frequency, high power application.

8. The process of claim 1 in which the component is suitable for high frequency, high power and high temperature operation.
